(19) United States
(12) Patent Application Publication
(10) Pub. No.: US 2008/0006077 A1
(43) Pub. Date: Jan. 10, 2008

(54) Near real-time air monitor having external injector and pressure based flow control

(76) Inventors: James Hansen Crabtree, Long Beach, CA (US); Hernan Diaz, Nottingham, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/263,126

(22) Filed: Oct. 31, 2005

(51) Int. Cl. G01N 1/18; G01N 1/44

(52) U.S. Cl. 73/23.41; 73/863.03; 73/1.06

(57) ABSTRACT

A pressure based flow control system for an air monitor comprises a chromatograph coupled to a thermal desorption unit in a spatially fixed relationship, an automatic liquid sampler coupled to the chromatograph, a vacuum source, a variable flow module having a pneumatic control module and a mass flow controller, wherein the variable flow module controls whether an inlet associated with the thermal desorption unit receives a sample to be analyzed or a calibrant, and a controller for automatically controlling a pressure setting of the pneumatic control module.

### BACKGROUND

Air monitoring is an important aspect in the detection of airborne chemical contaminants. Airborne chemical contaminants include, for example, the emissions from chemical manufacturing facilities, toxic industrial compounds and chemicals used in warfare, referred to as chemical warfare agents. Such compounds are often referred to as “target” compounds. The rapid detection of airborne chemical warfare agents is necessary for worker protection during the destruction of such agents, and for other applications.

In an instrumentation system that is used to monitor an industrial facility that may leak hazardous substances (e.g., a facility that is disassembling and disposing chemical weapons), a variety of instruments may be deployed throughout the plant and its environs. Where traces of toxic compounds in air, for example, may be present along with other compounds either from the plant or from the background air, the preferred instrument package is an air concentrator/desorber, also referred to as a thermal desorption unit (TDU) connected to a gas chromatograph. This type of instrument package is deployed throughout the facility in a variety of locations where workers may be present. These locations include areas of the plant where the toxic compounds are only occasionally present and then only at very low levels, areas where the toxic compounds are more frequently present and, if present, may be encountered at hazardous levels, and areas around the perimeter of the plant. Perimeter monitoring is normally done by collecting samples of air at various locations around the periphery of the facility. These samples are returned to the laboratory and analyzed to assure that emissions from the plant are below levels deemed to be hazardous to the general population as established by regulatory authorities. In other air monitoring applications it is desirable to transport the air monitor to the target instead of transporting the target material to the air monitor. These air samples are analyzed using, for example, gas chromatography to detect the presence and amounts of hazardous substances. In many of these situations, the ability to rapidly collect the air sample, and rapidly analyze it is extremely important. In order to protect the workers from undue exposure the regulatory authority may require that the total sampling, analysis and reporting time be less than or equal to a predetermined time (e.g., 15 minutes). An instrument package of this type is referred to as a Near-Real-Time or NRT air monitor.

One of the drawbacks of an air monitor that incorporates a thermal desorption unit and a gas chromatograph is the need to frequently disconnect and reconnect the thermal desorption unit from the sample line. Typically, a predetermined quantity of a known compound, sometimes referred to as a calibrant, is injected manually into the thermal desorption unit so that the unit can be calibrated. Then, the input port of the thermal desorption unit is reconnected to the air sampling tube so that an air sample may be collected and analyzed. Unfortunately, frequently disconnecting and reconnecting the thermal desorption unit is time consuming and leads to imprecise results.

Another drawback with the above described air monitor is that it is difficult to manually inject a precise quantity of calibrant into the thermal desorption unit when performing the calibration procedure.

Therefore, it would be desirable to overcome the above-mentioned drawbacks.

### SUMMARY OF THE INVENTION

According to an embodiment, a pressure based flow control system for an air monitor comprises a chromatograph coupled to a thermal desorption unit in a spatially fixed relationship, an automatic liquid sampler coupled to the chromatograph, a vacuum source, a variable flow module having a pneumatic control module and a mass flow controller, wherein the variable flow module controls whether an inlet associated with the thermal desorption unit receives a sample to be analyzed or a calibrant, and a controller for automatically controlling a pressure setting of the pneumatic control module.

Other aspects and features of the invention will be discussed with reference to the figures and to the detailed description of the preferred embodiments.

### BRIEF DESCRIPTION OF THE FIGURES

The invention will be described by way of example, in the description of exemplary embodiments, with particular reference to the accompanying figures in which:

FIG. 1 is a schematic view illustrating a near real-time air monitor in accordance with an embodiment of the invention.

FIG. 2 is a schematic diagram illustrating a computer system associated with the air monitor of FIG. 1.

FIGS. 3A and 3B are schematic diagrams collectively illustrating the injection mode and sampling mode of the air monitor of FIG. 1.

FIG. 4 is a flow chart illustrating the operation of an embodiment of the air monitor of FIG. 1.

### DETAILED DESCRIPTION

While described below for use in collecting air samples, the near real-time chemical monitor having external injector and pressure based flow control, referred to hereafter referred to as “air monitor,” can be used to sample any fluid matrix, and can be in a fixed environment or can be portably mounted in a vehicle, or other system to rapidly and efficiently detect and analyze collected substances. In one example, the detection of trace amounts, on the order of 100 nanograms/meter³, of what is referred to as “mustard gas” is desired. It is desired to measure and report the presence of mustard gas in a fifteen minute cycle, which includes sampling and analyzing the sample. In another example, the air monitor is used to detect the presence of so called “VX” vapor in concentrations on the order of 0.25 nanograms/meter³.

The air monitor can be implemented in hardware, software, or a combination of hardware and software. When implemented in hardware, the air monitor can be implemented using specialized hardware elements and logic. When the air monitor is implemented partially in software, the software portion can be used to control various operating aspects of the air monitor. The software can be stored in a memory and executed by a suitable instruction execution system (microprocessor). The hardware implementation of the air monitor can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the air monitor comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

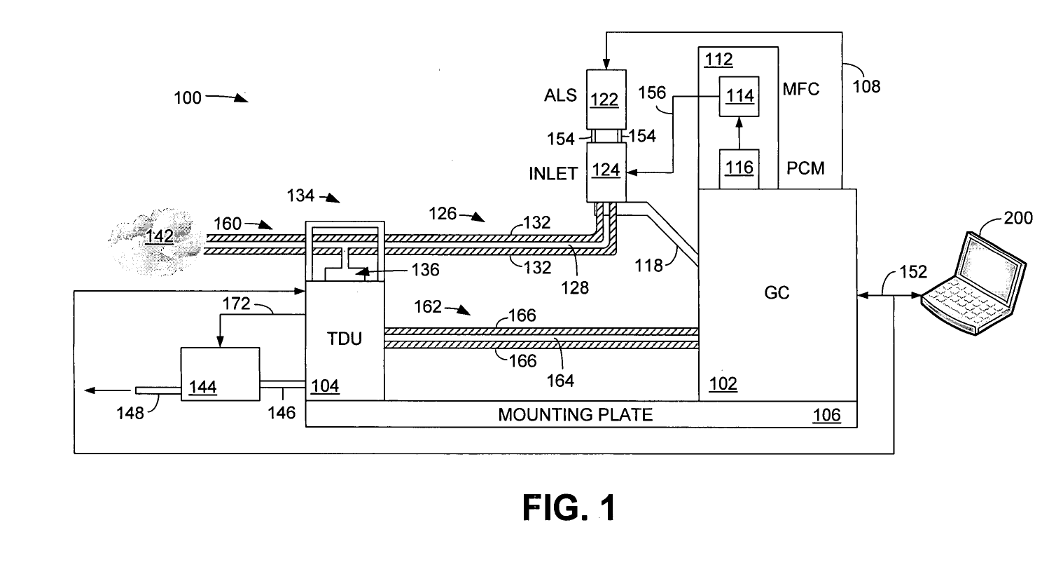

FIG. 1 is a schematic view illustrating an air monitor 100 constructed in accordance with an embodiment of the invention. The air monitor 100 comprises a gas chromatograph 102 and a thermal desorption unit 104 mounted on a mounting plate 106. The mounting plate 106 arranges the gas chromatograph and the thermal desorption unit 104 in a fixed relationship. Alternatively, the thermal desorption unit 104 can be mounted directly to the gas chromatograph 102. In other embodiments, a liquid chromatograph may be used instead of a gas chromatograph.

The air monitor 100 also comprises a variable flow module 112 associated with the gas chromatograph 102. The variable flow module 112 comprises a pneumatic control module 116 and a mass flow controller 114. In an embodiment in accordance with the invention, the pneumatic control module 116 controls an inlet gas source, also referred to as a carrier gas, at a pressure ranging from approximately 0-100 pounds per square inch gauge pressure (psig). The mass flow controller 114 can supply the carrier gas at approximately 0-1500 cubic centimeters per minute (ccm). As will be described more fully below, the variable flow module 112, together with other elements to be described, perform a pressure-based methodology to control the source of flow to an inlet of the thermal desorption unit 104.

The air monitor 100 also comprises an inlet 124. The inlet 124 can be, for example, a purged packed inlet, suitable for use with a thermal desorption unit. The inlet 124 can be mounted via bracketry 118 to the gas chromatograph 102. The bracketry 118 should be fabricated to hold the inlet 124 in a fixed relationship with respect to the gas chromatograph 102. The output of the mass flow controller 114 via connection 156 is the carrier gas at the appropriate pressure and volume of the desired operation. In accordance with an embodiment of the invention, an automatic liquid sampler 122 is coupled to the inlet 124 via mounting bracketry 154. The bracketry 154 should be fabricated to hold the automatic liquid sampler 122 in a fixed relationship with respect to the inlet 124. During injection mode operation when the air monitor 100 is calibrated, the automatic liquid sampler 122 supplies a precise amount of a known sample material, also referred to as a calibrant, to the inlet of the thermal desorption unit 104. The automatic liquid sampler 122 is electronically coupled to the gas chromatograph 102 via connection 108, which can be, for example, a serial data connection that enables the gas chromatograph 102 to control the operation of the automatic liquid sampler 122 according to a predefined program, or manually as will be described below.

The inlet 124 is coupled to the thermal desorption unit 104 via a fluid coupling 126. The fluid coupling 126 comprises a tube 128 surrounded by a heating element 132. The tube 128 is preferably treated, passivated, or otherwise prepared, to be chemically inert with respect to the material flowing through the tube. Two known passivation process for treating the tube 128 include the Sulfiner® process and the Silcosteel® process, both registered trademarks of Restek Performance Coatings. In accordance with an embodiment of the invention, fixing the spatial relationship between the thermal desorption unit 104 and the gas chromatograph 102 on the mounting plate 106, significantly reduces the possibility of the passivation on the tube 128 failing due to mechanical movement once the tube 128 is coupled to the inlet 124 and to the thermal desorption unit 104.

The fluid coupling 126 extends to a sample tee 134 located on the thermal desorption unit 104. The sample tee 134 couples to an inlet 136 located on the thermal desorption unit 104. The fluid coupling 126 extends past the sample tee 134 and a portion thereof, referred to as a sample input coupling 160, extends into a region 142 containing material to be sampled. The region 142 may be any location where airborne chemical contaminants and/or agents may be located. In one embodiment, the region 142 may be a compartment that is used for chemical weapons disposal or other associated activities. The compartment may be what is referred to as category A, where it is desirable to monitor for a maximum control limit. Alternatively, the compartment may be what is referred to as category B, where it is desirable to monitor for engineering control limits, or the compartment may be what is referred to as category C, where it is desirable to monitor for short term exposure limits.

In another embodiment, the air monitor 100 can be coupled to what is referred to as a fume hood. In yet another alternative embodiment, the air monitor 100 is mounted, or otherwise contained in a mobile vehicle.

The thermal desorption unit 104 is also coupled via transfer line 162 to the gas chromatograph 102. The transfer line 162 transfers the desorbed sample material from the thermal desorption unit 104 to the gas chromatograph 102 for analysis. The transfer line 162 comprises a tube 164 and a heating element 166. The tube 164 can be passivated similar to the tube 128 described above.

The thermal desorption unit 104 generally comprises two passivated traps for adsorbing and desorbing air samples from a sorbtion bed comprising one or more types of sorbents suitable for the materials being sampled. The thermal desorption unit 104 operates such that one trap is sampling while the other trap is desorbing. The top of the current sampling trap is connected via a heated valve to the sampling tee 134. The bottom of the current sampling trap is connected via tubing and to connection 146 to a vacuum pump 144 capable of regulating flow between approximately 0-1200 milliliters per minute. The bottom of the current desorbing trap is connected via valves to a carrier gas supply. The top of the current desorbing trap is connected to a capillary column for performing the separation of the components in the sample. The operation of an example trap is described in U.S. patent application Ser. No. 10/872,865, entitled “Low Thermal Mass Multiple Tube Capillary Sampling Array,” attorney docket no. 10040037-1, which is incorporated herein by reference.

A computer system 200 is coupled to the gas chromatograph 102 and to the thermal desorption unit 104. The thermal desorption unit 104 is coupled to and controls the flow generated by its vacuum pump 144 via connection 172. The computer system 200 can be any computing device containing a processor and memory to execute software that can be used to control the operation of the gas chromatograph 102 and the thermal desorption unit 104.

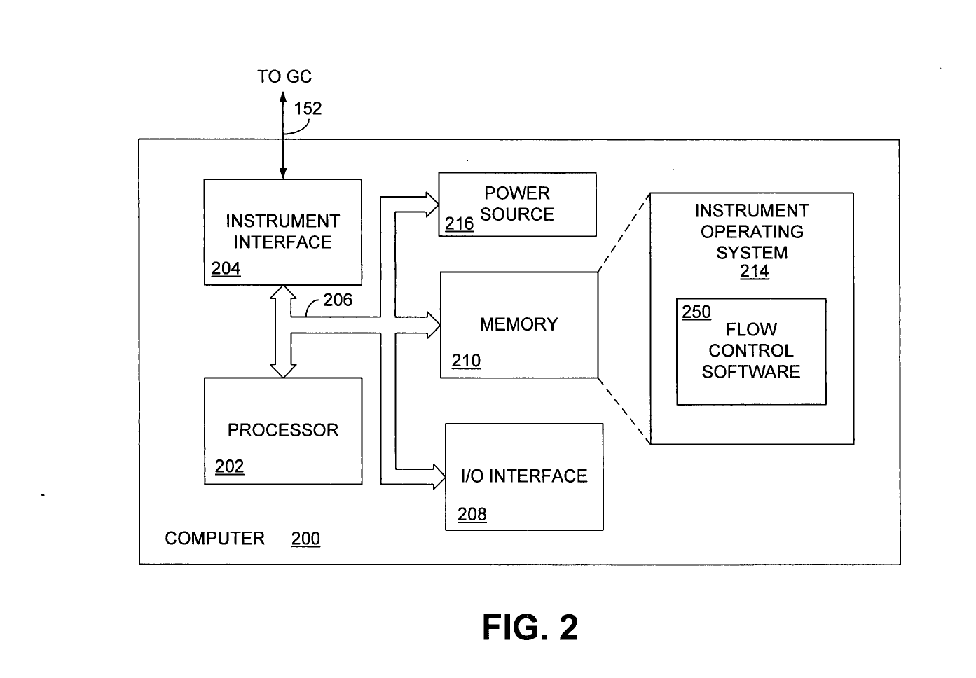

FIG. 2 is a schematic diagram illustrating the computer system of FIG. 1. The computer system 200 comprises a processor 202, memory 210, input/output (I/O) interface 208, power source 216 and instrument interface 204 in communication via bus 206. Bus 206, although shown as a single bus, may be implemented using multiple busses connected as necessary among the elements in the computer system 200.

The processor 202 and memory 210 provide the signal timing, processing and storage functions for the computer system 200. The I/O interface generally comprises the input and output mechanisms associated with the computer system 200. For example, the I/O interface may comprise a keyboard, mouse, stylus, pointer, or other input mechanisms. The output interface may comprise a display, printer, or other output mechanism. The instrument interface 204 comprises the hardware and software used to couple the computer system 200 to the gas chromatograph 102 and the vacuum pump 144 and to enable communication and control between those elements. The power source 216 may comprise a direct current (DC) or an alternating current (AC) power source.

The memory 210 comprises instrument operating system software 214 and flow control software 250. The instrument operating system software 214 comprises the instructions and executable code for controlling the operation of the gas chromatograph 102 and the thermal desorption unit 104. In one example, the instrument operating system software 214 may be a proprietary operating system. The flow control software 250 is a separate software module that can be implemented independently of the instrument operating system software 214. The flow control software 250 can be invoked to allow a user of the air monitor 100 to manually control the flow to the inlet 136 of the thermal desorption unit 104. A user can also control the flow to the vacuum pump 144 via command to the thermal desorption unit's control interface (not shown). In an embodiment, the flow control software 250 allows a user to determine whether the flow directed to the inlet 136 originates from the inlet 124 or from the sample region 142. The flow control software 250 also allows a user to manually inject a precise amount of calibrant using the automatic liquid sampler 122 into the input 136 of the thermal desorption unit while controlling the flow to the input 136 using the variable flow module 112. For example, the flow control software 250 can be programmed to automatically adjust the flow of the variable flow module 112 when it is desired to inject a calibrant into the thermal desorption unit 104, and then readjust, or reprogram the flow of the variable flow module 112 when it is desired to introduce a sample from region 142 to the inlet 136 of the thermal desorption unit 104.

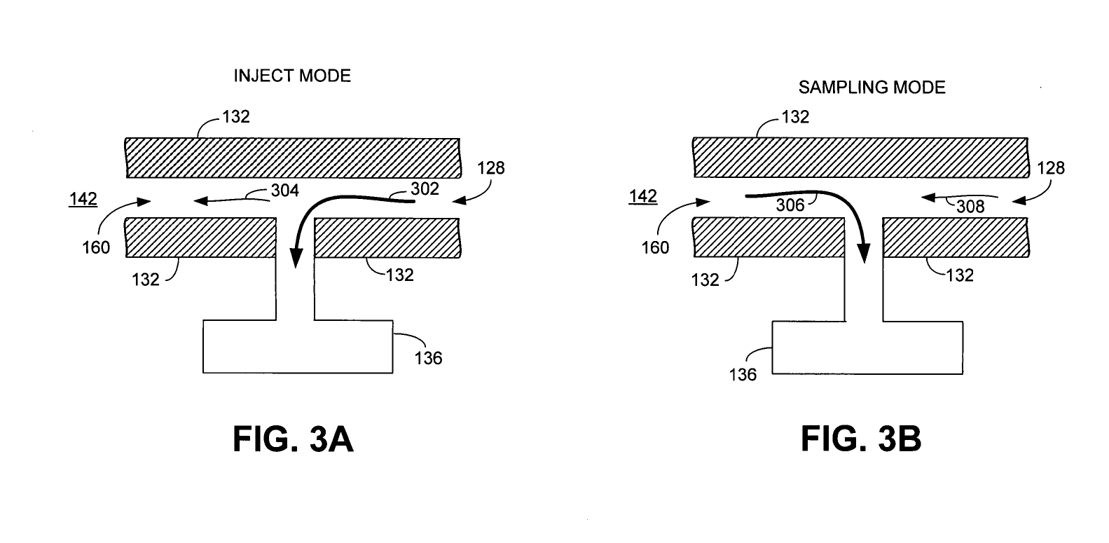

FIGS. 3A and 3B are schematic diagrams collectively illustrating the injection mode and sampling mode of the air monitor of FIG. 1. FIGS. 3A and 3B illustrate the flow through the sample tee 134 and the inlet 136 of the thermal desorption unit 104 under different operating conditions. FIG. 3A illustrates the flow through the sample tee 134 in the injection mode. The injection mode refers to a mode of operation during which a precise amount of calibrant is injected from the automatic liquid sampler 122 into the inlet 136 of the thermal desorption unit 104. To perform the injection of the calibrant, it is desirable to prevent, or minimize the flow of sample material from the region 142 into the inlet 136, preferably without disconnecting any fluid couplings. In the injection mode, the variable flow module 112 is controlled by the flow control software 250 (FIG. 2) so that the pressure supplied by the pneumatic control module 116 is raised to a relatively high pressure, on the order of 80 psig. This causes the mass flow controller 114 to provide a carrier gas flow of approximately 1020 ccm to the inlet 124. While this flow is occurring, the automatic liquid sampler 122 is caused to inject a precise amount of calibrant into the inlet 124. The vacuum pump 144 is set to operate at approximately 1000 ccm. The vacuum pump 144 causes the flow of the carrier gas through the inlet 124 to transport the calibrant to the inlet 136 of the sample tee 134, as illustrated using arrow 302. The pressure and flow created by the variable flow module 112 causes a small amount of flow past the sample tee 134 and toward the region 142, indicated using arrow 304. This flow 304 purges the inlet of sample material and allows accurate calibration of the thermal desorption unit 104 and gas chromatograph 102 without disconnecting any of the fluid couplings described above.

FIG. 3B illustrates the flow through the sample tee 134 in the sample mode. The sample mode refers to a mode of operation during which a sample of air, or other chemical, is obtained from the region 142 and directed into the inlet 136 of the thermal desorption unit 104. To perform sampling, it is desirable to encourage the flow of sample material from the region 142 into the inlet 136. In the sample mode, the flow through vacuum pump 114 is set to operate at approximately 1000 ccm, and the variable flow module 112 is controlled by the flow control software 250 (FIG. 2) so that the pressure supplied by the pneumatic control module 116 is lowered to a relatively low pressure on the order of 5 psig. This causes the mass flow controller 114 to provide a carrier gas flow of approximately 20 ccm to the inlet 124. This causes the majority of the flow to be drawn by the vacuum pump 144 through the region 142 and into the inlet 136, as illustrated using arrow 306. Conversely, very little flow occurs from the inlet 124, as illustrated using arrow 308.

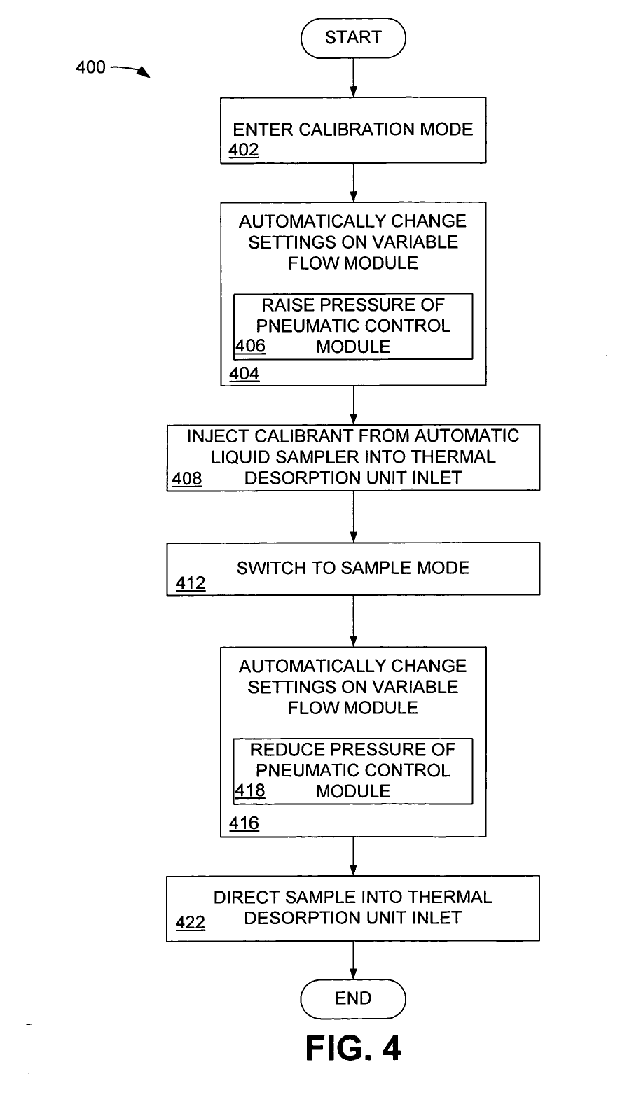

FIG. 4 is a flow chart illustrating the operation of an embodiment of the air monitor of FIG. 1. The blocks in the flowchart can be performed in the order shown or out of the order shown, or can be performed in parallel. In block 402, the flow control software 250 is placed in calibration mode. In block 404, the flow control software 250 automatically changes the settings of the variable flow module 112. The flow of sample through the sorbent bed of the thermal desorption unit 104 to its vacuum pump 114 normally remains at approximately 1000 ccm, although that can be changed by the flow control software 250 as well as via its interface to the thermal desorption unit 104. Block 406 is illustrated within block 404 to show that the pneumatic control module 116 is one of the elements that can be controlled by the calibration injection software 250. In block 406, the setting of the pneumatic control module 116 is adjusted to approximately 80 psig and the setting of the mass flow controller 114 is adjusted to approximately 1020 ccm. In block 408 a precise amount of calibrant is injected into the inlet 124 by the automatic liquid sampler 122. The settings of the vacuum pump 144 and the variable flow module 112 cause the majority of the flow to be drawn from the inlet 124, thus injecting the calibrant into the inlet 136 of the thermal desorption unit 104.

In block 412 the flow control software 250 switches to sample mode. In block 416, the flow control software 250 automatically changes the settings of the variable flow module 112 and the vacuum pump 144. Block 418 is illustrated within block 416 to show that the pneumatic control module 116 is one of the elements that can be controlled by the flow control software 250. In block 418, the setting of the pneumatic control module 116 is adjusted to approximately 5 psig and the setting of the mass flow controller 114 is adjusted to approximately 20 ccm. In block 422, sample material in the region 142 is drawn by the vacuum pump 144 into the inlet 136 of the thermal desorption unit 104.

In this manner, it is simple to switch between injection mode and sampling mode, while accurately supplying a precise amount of calibrant to the thermal desorption unit 104, and without disconnecting any fluid couplings. This pressure based flow switching causes a reversal of flow between the inlet 124 and the thermal desorption unit 104, thus enabling the use of an automatic liquid sampler 122 to provide a precise amount of calibrant, and without requiring the disassembly of any fluid components.

The foregoing detailed description has been given for understanding exemplary implementations of the invention in the gas phase only and no unnecessary limitations should be understood therefrom as modifications will be obvious to those skilled in the art without departing from the scope of the appended claims and their equivalents.

What is claimed is:

1. A system for switching flow to an inlet of a thermal desorption unit, comprising:
a chromatograph coupled to the thermal desorption unit in a spatially fixed relationship;
an automatic liquid sampler coupled to the chromatograph;
a vacuum source; and
a variable flow module having a pneumatic control module and a mass flow controller, wherein the variable flow module controls whether the inlet receives a sample to be analyzed or a calibrant.

2. The system of claim 1, further comprising chemically inert tubing between the thermal desorption unit and the chromatograph.

3. The system of claim 2, wherein when the pneumatic control module is set to a first pressure, a sample to be analyzed is directed to the inlet of the thermal desorption unit.

4. The system of claim 2, wherein when the pneumatic control module is set to a second pressure, a calibrant is directed to the inlet of the thermal desorption unit.

5. The system of claim 4, wherein the calibrant is supplied from an automatic liquid sampler.

6. The system of claim 5, wherein the automatic liquid sampler allows a user of the system to manually inject a precise amount of calibrant into the inlet of the thermal desorption unit.

7. The system of claim 2, wherein controlling the pressure of the pneumatic control module forms a pressure based switch at the inlet of the thermal desorption unit.

8. A pressure based flow control system for an air monitor, comprising:
a chromatograph coupled to a thermal desorption unit in a spatially fixed relationship;
an automatic liquid sampler coupled to the chromatograph;
a vacuum source;
a variable flow module comprising a pneumatic control module and a mass flow controller, wherein the variable flow module controls whether an inlet associated with the thermal desorption unit receives a sample to be analyzed or a calibrant; and
a controller for automatically controlling a pressure setting of the pneumatic control module.

9. The system of claim 8, further comprising chemically inert tubing between the thermal desorption unit and the chromatograph.

10. The system of claim 8, wherein the variable flow module and the vacuum source form a pressure based switch at the inlet of the thermal desorption unit.

11. The system of claim 10, wherein the calibrant is supplied from an automatic liquid sampler.

12. The system of claim 11, wherein the automatic liquid sampler allows a user of the system to manually inject a precise amount of calibrant into the inlet of the thermal desorption unit.

13. The system of claim 12, wherein the chemically inert tubing remains coupled to the thermal desorption unit and the gas chromatograph regardless of whether the thermal desorption unit receives the sample or the calibrant.

14. The system of claim 12, wherein the automatic liquid sampler is mounted external to the chromatograph.

15. The system of claim 14, wherein the automatic liquid sampler is controlled by a communication line from the chromatograph.

16. The system of claim 10, wherein the controller switches between directing flow from the automatic liquid sampler to a thermal desorption unit and directing flow from a sample environment to the thermal desorption unit while leaving all fluid coupling between the thermal desorption unit and a gas chromatograph intact.

17. The system of claim 16, wherein controlling the pressure of the pneumatic control module forms a pressure based switch at the inlet of the thermal desorption unit.

18. A method for controlling an air monitor, comprising:
directing flow from an automatic liquid sampler to a thermal desorption unit during a calibration cycle by setting a pressure and flow characteristic of a variable flow module;
injecting a calibrant into the thermal desorption unit;
directing flow from a sample environment to a thermal desorption unit during a sample cycle by automatically readjusting a pressure and flow characteristic of the variable flow module.

19. The method of claim 18, further comprising automatically setting the pressure and flow characteristics based on a predetermined factor.

20. The method of claim 19, further comprising switching between directing flow from the automatic liquid sampler to a thermal desorption unit and directing flow from the sample environment to the thermal desorption unit without disconnecting a fluid coupling between the thermal desorption unit and a gas chromatograph.
